(19) United States
(12) Patent Application Publication
(10) Pub. No.: US 2025/0107600 A1
(43) Pub. Date: Apr. 3, 2025

(54) GEMSTONE

(71) Applicant: IDD LIMITED, Wellington (NZ)

(72) Inventors: Ian B. DOUGLAS, Wellington (NZ); Michiel J. BOTHA, Prince Albert (CA)

(73) Assignee: IDD LIMITED, Wellington (NZ)

(21) Appl. No.: 18/981,005

(22) Filed: Dec. 13, 2024

Related U.S. Application Data
(63) Continuation of application No. 16/823,101, filed on Mar. 18, 2020, now abandoned.
Application No. 16/823,101 is a continuation of application No. 15/477,640, filed on Apr. 3, 2017, now abandoned.
(60) Provisional application No. 62/375,011, filed on Aug. 15, 2016.

(51) Int. Cl. A44C 17/00; A44C 1/00; A44C 5/00; A44C 7/00; A44C 9/00; A44C 15/00; A44C 17/02; A44C 25/00; B23K 26/364; B23K 26/402; B23K 103/00; B28D 5/04

(52) U.S. Cl. CPC A44C 17/005; A44C 1/00; A44C 5/00; A44C 7/00; A44C 9/00; A44C 15/005; A44C 17/001; A44C 17/02; A44C 25/001; B23K 26/364; B23K 26/402; B28D 5/04; B23K 2103/50

(57) ABSTRACT

The present invention provides a gemstone comprising a girdle dividing the gemstone into a pavilion and a crown having a table surface; a tier of facets cut into the pavilion at a position immediately below the girdle; and a continuous groove. The groove facilitates mounting to a collet having a mounting rim. The continuous groove is located in the tier of the facets cut into the pavilion. The placement of the tier of facets and continuous groove does not obstruct light return.

### CROSS-RELATED APPLICATION DATA

The application is a continuation of U.S. patent application Ser. No. 16/823, 101 filed on Mar. 18, 2020, which in turn is a continuation of U.S. patent application Ser. No. 15/477,640, filed on Apr. 3, 2017, which claims priority to U.S. Provisional Application Ser. No. 62/375,011, filed Aug. 15, 2016, the disclosures of which are hereby incorporated by reference in their entirety.

### FIELD OF THE INVENTION

The present invention relates to gemstones and gemstones that permit easy mounting to form a part of a jewelry item.

### BACKGROUND OF THE INVENTION

Gemstones like diamonds are cut from rough stones. A diamond cutter will aim to maximize the girdle diameter and carat weight of the diamond that is formed from a given ‘rough’. Once cut, the diamond or gemstone is traditionally secured in a setting called a collet. Various collets are known and may form parts of so-called “jewelry findings” such as, but not limited to, rings, earrings, bracelets, pendants, necklaces, bangles, brooches and lockets. In many instances, a strong consideration for the setting design is how well the gemstone is presented, in order that its size and brilliance can be appreciated, and all traditional settings do, to some degree, obscure the full vision of the gemstone.

There are several traditional methods for holding the gemstone in its collet. One common example is the use of prongs or claws that hold the gemstone in place. The downside of this method is that the prongs or claws could snag onto clothing or worse, they could bend or wear away, causing the gemstone to fall out and possibly get lost. Another method is a bezel or part bezel mounting which consists of a barrel or part barrel, whereby the gemstone is held in place by metal being hammered over the girdle of gemstone thereby holding the gemstone in place, which is also called a ‘rub-over’ setting. Although this is a secure method of holding a gemstone in place, it will impede the visibility of the full diameter of the gemstone and is also susceptible to wearing away over time.

Another method is a tension setting that holds the gemstone in place at opposite ends utilizing tension. This setting also obscures a portion of the gemstone in order to locate the stone, and the tension in the setting tends to relax over time, allowing the gemstone to fall out and possibly get lost.

Another solution is proposed by U.S. Pat. No. 5,115,649 to Amber. Amber provides a gemstone having four inclined grooves or notches cut into the pavilion that mate with four protruding wedges of a deformable metal. The metal protruding wedges are hammered into the four inclining notches to secure the gemstone. The four wedges in the gemstone, however, have the appearance of inclusions which impede light return and adversely affect the aesthetics of the gemstone set in accordance with Amber.

Yet another solution is proposed by U.S. Patent Publication No. 2011/0302959 A1 to Wcslo. Wcslo proposes a gemstone fitted with a connecting or setting material which is then used to attach the gemstone to a jewelry piece. The connecting material or setting material is placed in the groove. The gemstone with the connecting material is then fitted into a jewelry setting by soldering or laser welding the connecting material and metal of the setting together. The gemstone grooves of Wcslo, however, are widely visible and impede light return of the gemstone particularly when a transparent gem is used.

Thus, there remains a need for mounting gemstones that permits easy attachment to a collet without adversely affecting the brilliance and aesthetic qualities of the gemstone

### SUMMARY OF THE INVENTION

The present invention provides a gemstone comprising a girdle dividing the gemstone into a pavilion and a crown having a table surface; an additional tier of facets cut into the pavilion at a position immediately below the girdle; and a continuous groove. The groove facilitates mounting to a collet having a mounting rim. The continuous groove is located in the tier of the facets cut into the pavilion. The continuous groove may have various geometries. For example, in one embodiment the groove may have a first surface substantially parallel to the table surface of the crown and a second surface inclined relative to the first surface at an angle of between about 60 and 80 degrees. The placement of the tier of facets and the geometry of continuous groove are selected so that light is not obstructed.

### BRIEF DESCRIPTION OF THE DRAWINGS

Those and other features of the invention will become more apparent from the following description in which reference is made to the appended drawings wherein:

FIG. 1 illustrates the side view of a gemstone in accordance with the present invention.

FIG. 2 is a magnified view of FIG. 1 showing one embodiment of the groove geometry.

FIG. 3 is an alternative embodiment of the groove geometry.

FIG. 4 illustrates a side view of a gemstone in accordance with the present invention with the position of a laser beam.

FIG. 5 illustrates a side view of the gemstone with the position of the laser beam and magnified section of laser beam spot illustrating a triangular profile.

FIG. 6 illustrates a gemstone in accordance with the present invention suspended above a mounting rim.

FIG. 7 illustrates a basket-type collet in accordance with the present invention.

FIG. 8 illustrates a barrel-type collet in accordance with the present invention.

FIG. 9 illustrates a ring with integrated mounting rim and a gemstone in accordance with the present invention held in place.

FIG. 10 illustrates a money clip, decorated with gemstones in accordance with the present invention held in mounting rims, which are integral to the money clip.

### DETAILED DESCRIPTION OF THE INVENTION

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a depth, width, angle and the like, is meant to encompass variations of 20%, 10%, 5%, 1%, 0.5%, or even 0.1% of the specified amount. When a range is employed (e.g., a range from x to y) it is it meant that the measurable value is a range from about x to about y, or any range therein, such as about x₁ to about y₁, etc. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

It will be understood that although the terms “first,” “second,” “third,” “a),” “b),” and “c),” etc. may be used herein to describe various elements of the invention should not necessarily be limited by these terms. These terms are only used to distinguish one element of the invention from another. Thus, a first element discussed below could be termed an element aspect, and similarly, a third without departing from the teachings of the present invention. Thus, the terms “first,” “second,” “third,” “a),” “b),” and “c),” etc. are not intended to necessarily convey a sequence or other hierarchy to the associated elements but are used for identification purposes only. The sequence of operations (or steps) is not necessarily limited to the order presented in the claims and/or drawings unless specifically indicated otherwise.

All patents, patent applications and publications referred to herein are incorporated by reference in their entirety. In the event of conflicting terminology, the present specification is controlling.

The embodiments described in one aspect of the present invention are not limited to the aspect described. The embodiments may also be applied to a different aspect of the invention as long as the embodiments do not prevent these aspects of the invention from operating for its intended purpose.

The present invention provides mounting for gemstones that allows for easy attachment to a collet without adversely affecting the brilliance and aesthetic qualities of the gemstones.

In one embodiment, the gemstone of the present invention is diamond. Exemplary other gemstones include precious and semi-precious stones such as amethyst, emerald, jade, opal, garnet, peridot, topaz, turquoise, ruby, sapphire, being either naturally occurring or synthetically produced.

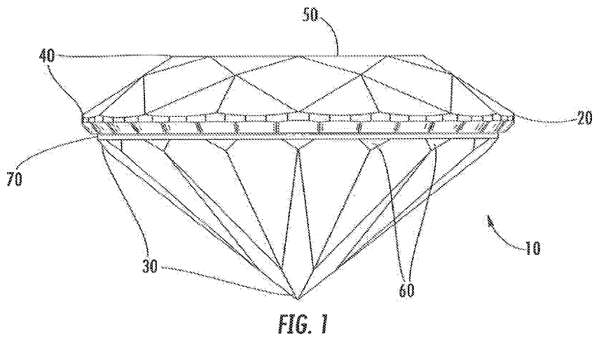

Referring to FIG. 1, the gemstone 10 includes a girdle 20 dividing the gemstone 10 into a pavilion 30 and a crown 40 having a table surface 50. A tier of facets 60 may be cut into the pavilion 30 at a position immediately below the girdle 20. The facets are cut using techniques known to those skilled in art. The facets are illustrated, for example, as being alternating rectangular and shield shaped. The selection of alternative shapes and/or patterns will be within the skill of one in the art.

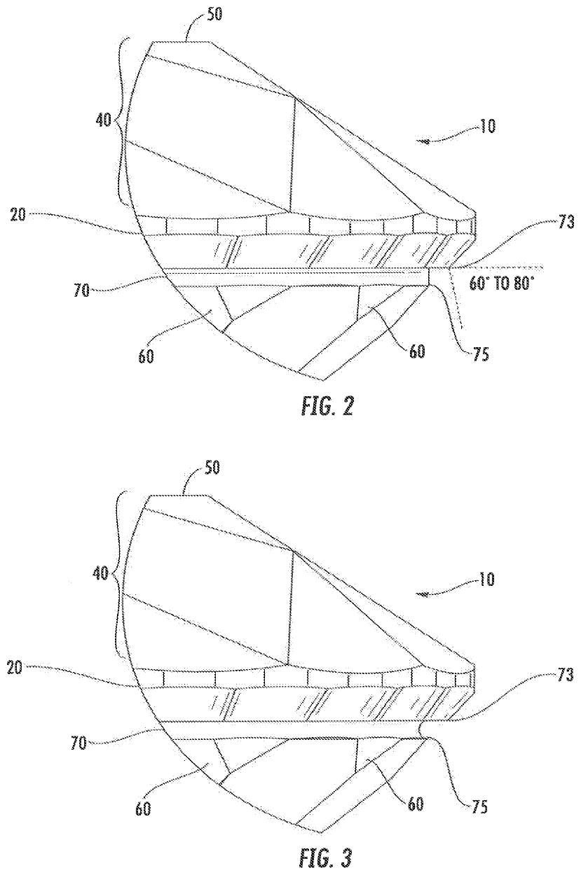

A continuous groove 70 is cut in the tier of facets 60 cut into the pavilion 30. The continuous groove 70 may be a concentric microgroove having a width of between 0.5 and 5% of the girdle diameter, and a depth of between 0.5 and 5% of the girdle diameter. Referring to FIG. 2, the continuous groove 70 has a first surface 73 substantially parallel to the table surface 50 of the crown 40 and a second surface 75 inclined relative to the first surface 73. In one embodiment, the inclination may be a notch cut to about 60 to 80 degrees. As shown in FIG. 3, the groove may in an alternative embodiment have a semi-circular geometry. Additionally, a wide variety of groove geometries or profiles may be cut such as rectangular, half round, v-shaped, oval shaped, u-shaped, trapezoidal, and the like. By placing the continuous groove 70 in the cut tier of facets 60, using the geometry of the continuous groove 70, and the proportions of the continuous groove 70 to the tier of facets 60, light return is not obstructed thus maintaining the aesthetic qualities of the gemstone.

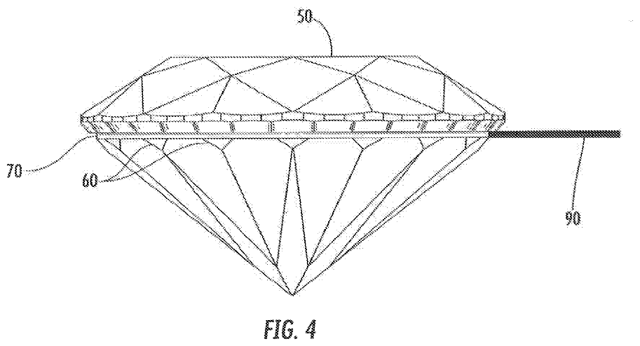

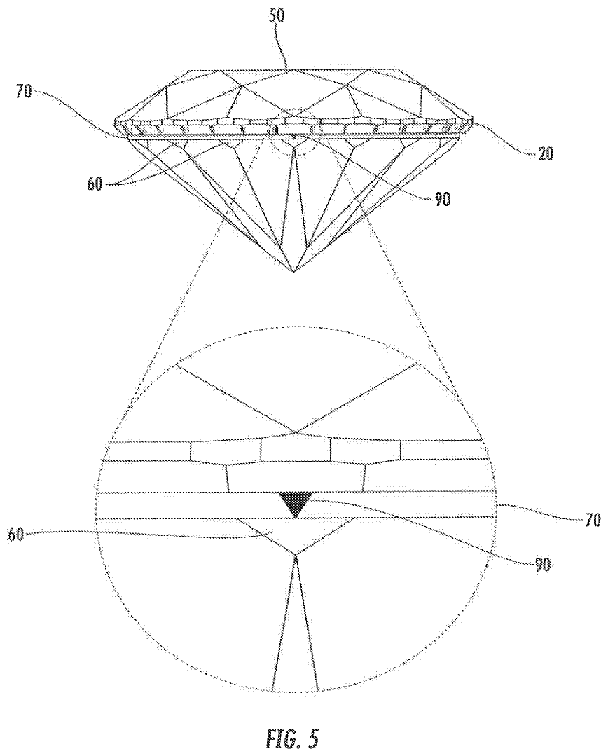

Referring to FIGS. 4 and 5, the method of cutting the continuous groove 70 with a laser beam is illustrated. The laser beam is utilized to cut the continuous groove 70 with a wide variety of profiles adapted to mate with a wide variety of mounting rims and collets. The profile of the laser beam is selected so that the placement of the tier of facets and the continuous groove 70 do not obstruct light return. The laser beam may be computer controlled. It is recognized that cutting techniques other than laser cutting may be utilized, such as a diamond grinding wheel or ceramic abrasive techniques. In operation, the gemstone 10 is rotated and a laser beam 90 (e.g., shown as having a triangular beam) is directed at the gemstone 10 to cut the continuous groove 70. The base of the laser beam 90 is directed substantially parallel to the table surface 50 of the gemstone 10. The laser beam, controlled by a computer program and software, has three axes, X, Y and Z to move gemstones during use and a fourth axis is added to rotate the gemstone 10, which creates the continuous groove 70 with the desired dimensions, angle (such as shown in FIG. 2) and the like by ablation of the gemstones 10.

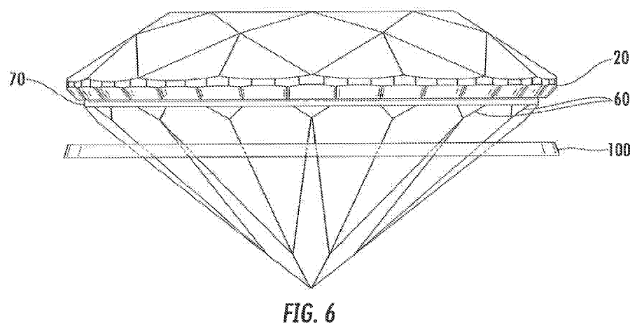

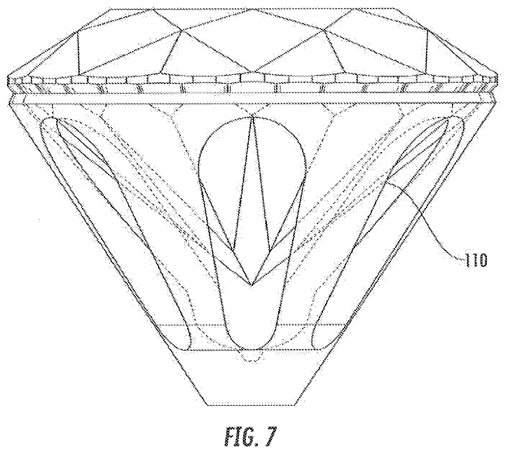

Various mounting rims may be provided to which the gemstones are mounted by locking the grooved gemstone 10 into place. Referring to FIG. 6, the gemstone 10 is shown suspended above a mounting rim 100. The gemstone is held or snapped into the mounting rim 100 by applying controlled pressure and travel distance to have the mounting rim 100 retain the gemstone 10 with an interference fit.

FIG. 7 illustrates a basket-type collet 110 with an integrated mounting rim 100 and gemstone 10 mounted (snapped) in place.

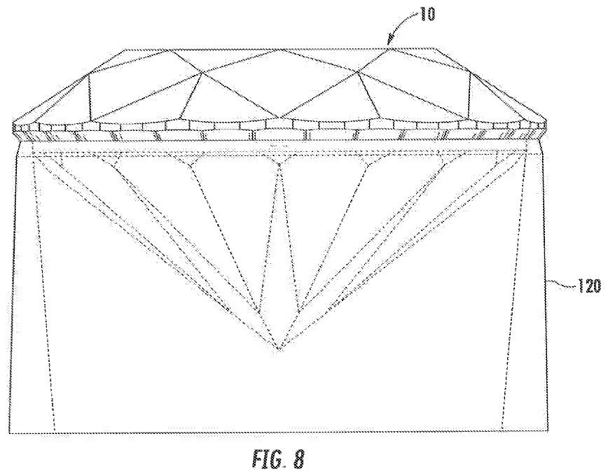

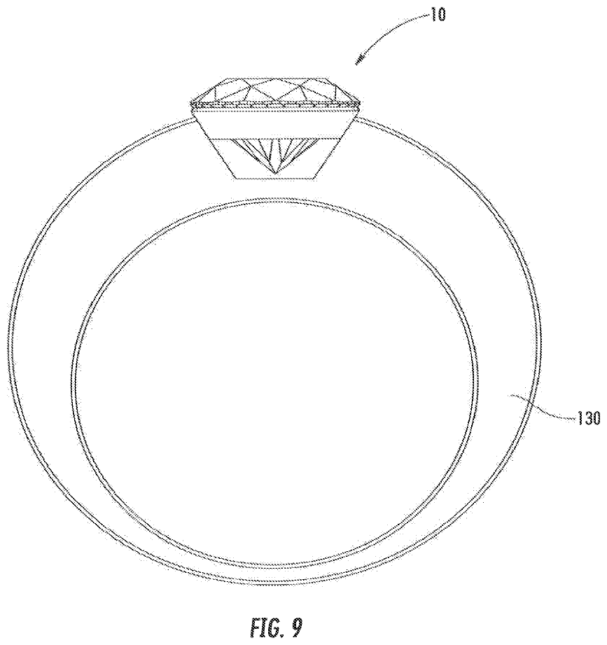

FIG. 8 illustrates a barrel-type collet 120 with integrated mounting rim 100 and gemstone 10 mounted in place.

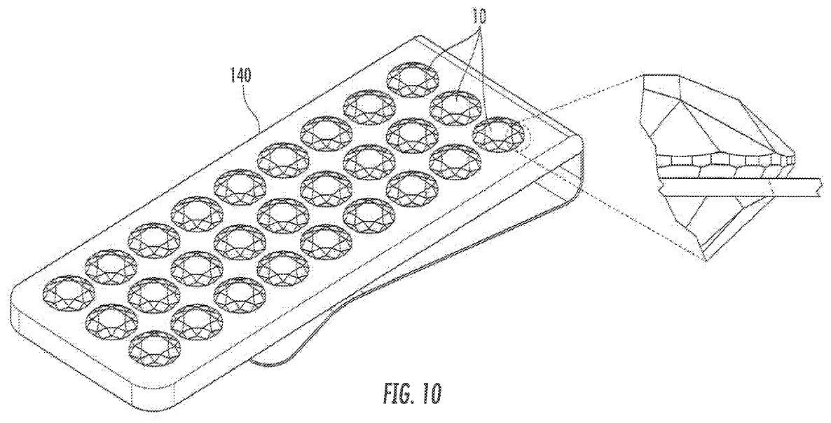

FIG. 9 illustrates a ring 130 with gemstone 10 mounted in place.

FIG. 10 illustrates a money clip 140 with integrated mounting rim 100 and multiple gemstones 10 mounted in place.

The present invention has been described with regard to one or more embodiments. However, it will be apparent to persons skilled in the art that a number of variations and modifications can be made without departing from the scope of the invention as defined in the claims.

That which is claimed is:

1. A gemstone comprising:
a) a girdle dividing the gemstone into a pavilion and a crown having a table surface;
b) a tier of facets cut into the pavilion at a position immediately below the girdle; and
c) a continuous groove to facilitate mounting to a collet having a mounting rim, the continuous groove located in the tier of facets cut into the pavilion wherein the placement of the tier of facets and continuous groove does not obstruct light return.

2. The gemstone according to claim 1, wherein the gemstone is a diamond.

3. The gemstone according to claim 1, wherein the continuous groove has a width of between 0.5% and 5% of the girdle diameter, and a depth of between 0.5% and 5% of the girdle diameter.

4. The gemstone according to claim 1 wherein the continuous groove has a shape selected from the group consisting of rectangular, half round, v-shaped, oval shaped, u-shaped, and trapezoidal,

5. A gemstone according to claim 1 mounted in a mounting rim.

6. A basket-type collet comprising the gemstone mounted in the mounting rim of claim 5.

7. A ring comprising the gemstone mounted in the mounting rim of claim 5.

8. A jewelry finding selected from the group consisting of money clips, rings, earrings, bracelets, pendants, necklaces, bangles, brooches and lockets and comprising at least one gemstone mounted in the mounting rim of claim 5.

9. A barrel-type collet comprising the gemstone mounted in the mounting rim of claim 5.

10. A gemstone comprising:
a) a girdle dividing the gemstone into a pavilion and a crown having a table surface;
b) a tier of facets cut into the pavilion at a position immediately below the girdle; and
c) a continuous groove to facilitate mounting to a collet having a mounting rim, the continuous groove located in the tier of facets cut into the pavilion, and having a first surface substantially parallel to the table surface of the crown and a second surface inclined relative to the first surface at an angle of between about 60 and 80 degrees, wherein the placement of the tier of facets and continuous groove does not obstruct light return.

11. The gemstone according to claim 10, wherein the gemstone is a diamond.

12. The gemstone according to claim 10, wherein the continuous groove has a width of between 0.5% and 5% of the girdle diameter, and a depth of between 0.5% and 5% of the girdle diameter.

13. A gemstone according to claim 10 mounted in a mounting rim.

14. A basket comprising the gemstone mounted in the mounting rim of claim 13.

15. A ring comprising the gemstone mounted in the mounting rim of claim 13.

16. A jewelry finding selected from the group consisting of money clips, rings, earrings, bracelets, pendants, necklaces, bangles, brooches and lockets and comprising at least one gemstone mounted in the mounting rim of claim 13.

17. A barrel comprising the gemstone mounted in the mounting rim of claim 13.

18. A method providing a gemstone comprising: a) cutting a tier of facets into a pavilion of a gemstone at a position immediately below a girdle of the gemstone and b) forming a continuous groove in the tier of facets to facilitate mounting of the gemstone to a collet having a mounting rim wherein the placement of the tier of facets and continuous groove does not obstruct light return.

19. The method according to claim 18, wherein the step of forming the continuous groove comprises cutting the gemstone using a laser beam.
